(19) United States
(12) Patent Application Publication
(10) Pub. No.: US 2022/0240451 A1
(43) Pub. Date: Aug. 4, 2022

(54) THREE POINT HAY LIFT SYSTEM

(71) Applicant: John C. Bishop, Cookeville, TN (US)

(72) Inventor: John C. Bishop, Cookeville, TN (US)

(21) Appl. No.: 17/162,930

(22) Filed: Jan. 29, 2021

(51) Int. Cl. A01D 87/12; A01D 87/00

(52) U.S. Cl. CPC A01D 87/127; A01D 87/0053

(57) ABSTRACT

A three point hay lift assembly includes a hay spear device for a three point hitch and a three point hay lift. The hay spear device includes at least one stabilizer mounted to a frame within about 24 inches of a hay spear mounted to the frame. This enables the hay spear device to be lowered without the stabilizers contacting a trailer platform or bed. The hay lift includes a tube configured to slide over the hay spear that is longer than the stabilizer of the hay spear device. A crossbar limits the insertion depth of the hay spear into the hay bale and at least one stabilizer is attached to the crossbar to prevent the hay bale from spinning. An ear extends from the tube to contact the frame of the hay spear device and prevent the tube from spinning about the hay spear.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to devices for moving round hay bales. More particularly, this invention pertains to systems and methods for stacking hay bales.

The standard hitch for farm tractors is a three point hitch. Three point hitches are used to pull and lift implements via a hydraulic system on the tractor. One of the most used implements for livestock farmers is a hay spear device for moving large, round bales of hay. A hay spear device typically includes a hay spear and one or more stabilizers mounted to a frame. A farmer backs the tractor up to a large round hay bale, inserting the spear and stabilizers into the bale up to the frame. The spear is typically nearly as long as or longer than the bale such that the bale is well supported on the spear for travel. The hydraulic system is then used to lift the bale slightly off the ground to move the bale for storage or from storage to a feeding area for livestock. The stabilizers prevent rotation of the bale about the spear in order to prevent the bale from twisting and coming into contact with the ground during transit which could damage the bale or pull the bale off the spear. The combination of existing hay spear devices and three point hitches limits the height to which a hay spear device and tractor can lift a bale. Therefore, a farmer needs a relatively expensive front hydraulic lift in order to stack round hay bales or load round hay bales on a trailer. Because front hydraulic lifts are typically not available for older tractor models, acquiring the ability to load round hay bales on a trailer or stack (and unstack) round hay bales typically involves renting an implement, paying someone to do the job, or buying a new tractor.

### BRIEF SUMMARY OF THE INVENTION

Aspects of the present invention provide a three point hay lift assembly. The three point hay lift assembly includes a hay spear device for a three point hitch and a three point hay lift. The hay spear device includes at least one stabilizer mounted to a frame within about 24 inches of a hay spear mounted to the frame. This enables the hay spear device to be lowered without the stabilizers contacting a trailer platform or bed. The hay lift includes a tube configured to slide over the hay spear that is longer than the stabilizer of the hay spear device. A crossbar limits the insertion depth of the hay spear into the hay bale and at least one stabilizer is attached to the crossbar to prevent the hay bale from spinning. An ear extends from the tube to contact the frame of the hay spear device and prevent the tube from spinning about the hay spear.

In one aspect, a three point hay lift includes a tube, an ear, a crossbar, and a hay lift stabilizer. The tube extends longitudinally along a longitudinal axis and is configured to receive a hay spear therein. The tube has a first end and a second end. The second end is longitudinally opposite the first end. The ear extends longitudinally past the first end of the tube. The ear is generally parallel to the longitudinal axis and not collinear with the longitudinal axis such that the ear is configured to contact the frame supporting the hay spear and limit rotation of the tube about the hay spear when the three point hay lift is installed on the hay spear device. The crossbar extends laterally from the tube at the second end of the tube. The hay lift stabilizer extends longitudinally from the crossbar past the second end of the tube. The hay lift stabilizer is generally parallel to the longitudinal axis and not collinear with the longitudinal axis.

In another aspect, a hay spear device includes a frame, a hay spear, and a hay spear stabilizer. The frame is configured to attach to a three point hitch. The hay spear extends longitudinally along a longitudinal axis. The spear is attached to and supported by the frame. The hay spear stabilizer extends longitudinally from the frame. The hay spear stabilizer extends generally parallel to the longitudinal axis and is not collinear with the longitudinal axis. The hay spear stabilizer is less than 24 inches from the hay spear.

In another aspect, a hay spear and three point hay lift assembly includes a hay spear device, and a three point hay lift. The hay spear device includes a frame, a hay spear, and a hay spear stabilizer. The frame is configured to attach to a three point hitch. The hay spear extends longitudinally along a longitudinal axis. The spear is attached to and supported by the frame. The hay spear stabilizer extends longitudinally from the frame. The hay spear stabilizer extends generally parallel to the longitudinal axis and is not collinear with the longitudinal axis. The hay spear stabilizer is less than 24 inches from the hay spear. The three point hay lift includes a tube, an ear, a crossbar, and a hay lift stabilizer. The tube extends longitudinally along the longitudinal axis and is configured to receive a hay spear therein. The tube has a first end and a second end. The second end is longitudinally opposite the first end. The ear extends longitudinally past the first end of the tube. The ear is generally parallel to the longitudinal axis and not collinear with the longitudinal axis such that the ear is configured to contact the frame supporting the hay spear and limit rotation of the tube about the hay spear when the three point hay lift is installed on the hay spear device. The crossbar extends laterally from the tube at the second end of the tube. The hay lift stabilizer extends longitudinally from the crossbar past the second end of the tube. The hay lift stabilizer is generally parallel to the longitudinal axis and not collinear with the longitudinal axis.

### BRIEF DESCRIPTION OF THE SEVERAL VIEWS OF THE DRAWINGS

FIG. 1 is an isometric view of a three point hay lift according to one embodiment of the invention.

FIG. 2 is an isometric view of a hay spear and three point hay lift assembly including the three point hay lift of FIG. 1 according to one embodiment of the invention.

FIG. 3 is a rear perspective view of the hay spear and three point hay lift assembly of FIG. 2 installed on a three point hitch in a lowered, level position.

FIG. 4 is a side perspective view of the hay spear and three point hay lift assembly of FIG. 2 partially inserted into a round hay bale.

FIG. 5 is a side perspective view of the hay spear and three point hay lift assembly of FIG. 4 fully inserted into the round hay bale.

FIG. 6 is a side perspective view of the hay spear and three point hay lift assembly of FIG. 5 inserted in the round hay bale and raised to a lifted position of the three point hitch.

FIG. 7 is a side perspective view of the hay spear and three point hay lift assembly of FIG. 6 holding the round hay bale over other round hay bales.

FIG. 8 is a side perspective view of the hay spear and three point hay lift assembly of FIG. 7 lowering the round hay bale onto the other round hay bales.

FIG. 9 is an isometric view of the hay spear and three point hay lift assembly of FIG. 6 lowering a hay bale onto a trailer.

FIG. 10 is an isometric view of the hay spear and three point hay lift assembly of a second embodiment of a hay spear device.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. As described herein, the upright position of the hay spear and three point hay lift assembly is with a hay spear device installed on a three point hitch in a lowered, level position such that the hay spear extends generally horizontally, and with the three point hay lift installed on the hay spear such that the ear contacts the side of the frame of the hay spear device. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

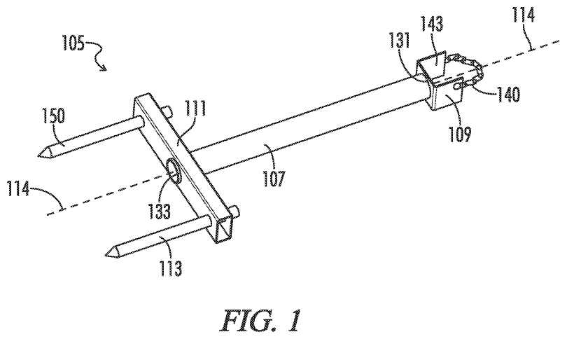

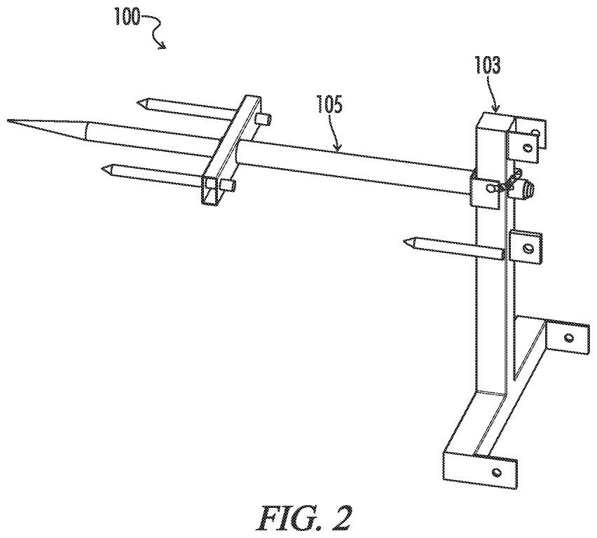

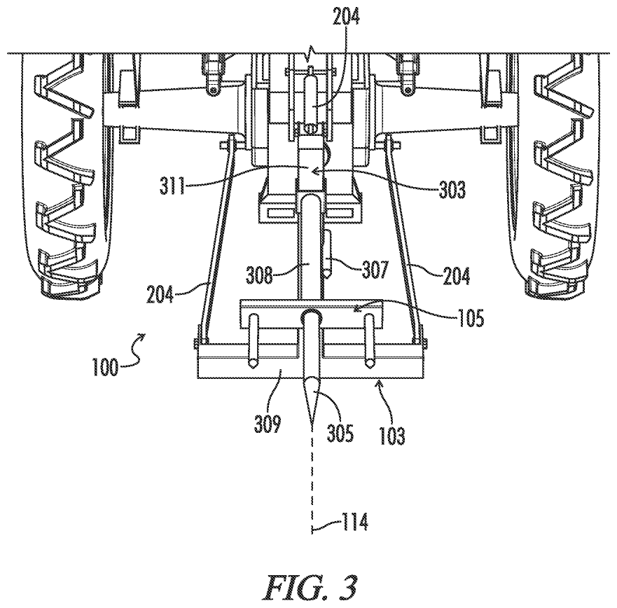

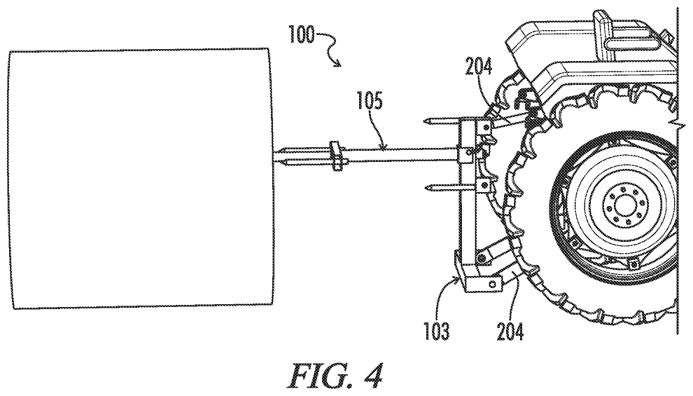

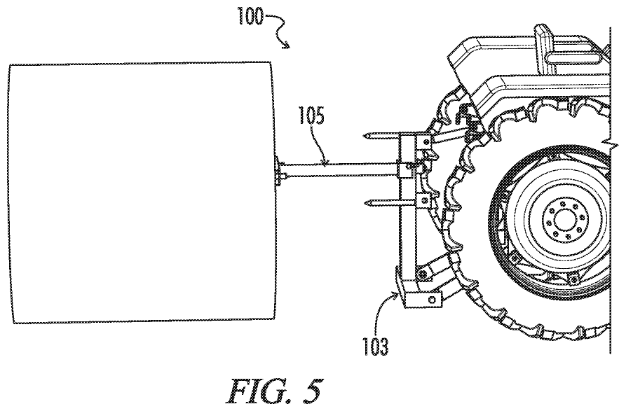

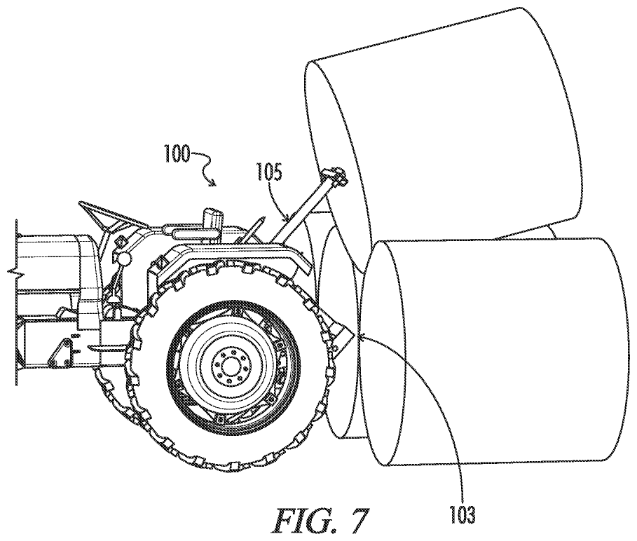

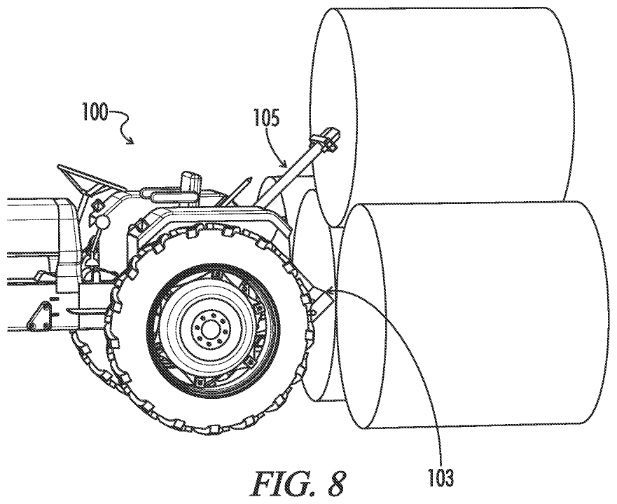

Referring now to FIGS. 1-10, a hay spear and three point hay lift assembly 100 includes a hay spear device 103 and three point hay lift 105. The hay spear device 105 includes a frame 303, a hay spear 305, and a hay spear stabilizer 307. The frame 303 is configured to attach to a three point hitch 204. In one embodiment, the frame includes a drawbar 309 and an upright 311. The drawbar 309 is configured to extend between a pair of lift arms of the three point hitch 204. The upright 311 is configured to extend from the center of the drawbar 309 to a top link of the three point hitch 204. In one embodiment, the crossbar 309 does not have a hay spear stabilizer 307 permanently affixed thereto.

The hay spear 305 extends longitudinally along a longitudinal axis 114. The hay spear 305 is attached to and supported by the frame 303. The hay spear stabilizer 307 extends longitudinally from the frame 303. In one embodiment, the hay spear 305 is laterally centered with respect to the upright 311 and the drawbar 309. In one embodiment, the hay spear 305 has a length between about 36 and 60 inches.

The hay spear stabilizer extends generally parallel to the longitudinal axis 114 and is not collinear with the longitudinal axis 114. The hay spear stabilizer 307 is less than 24 inches from the hay spear 305. In one embodiment, the hay spear stabilizer 307 is not laterally centered with respect to the upright 311 and the drawbar 309. In one embodiment, the hay spear stabilizer 307 is a first hay spear stabilizer, and the hay spear assembly 103 further includes a second hay spear stabilizer 308. The first and second hay spear stabilizers 307, 308 are attached to opposing lateral sides of the upright 311. In one embodiment, the hay spear stabilizers 307, 308 have a length of between 12 and 20 inches.

The three point hay lift 105 includes a tube 107, and ear 109, a cross bar 111, and a hay lift stabilizer 113. The tube 107 extends longitudinally along the longitudinal axis 114 and is configured to receive the hay spear 305 therein. The tube 107 has a first end 131 and a second end 133. The second end 133 is longitudinally opposite the first end 131. In one embodiment, the tube 107 has a length less than half a length of the hay spear 305. In one embodiment, the tube 107 has a length between 12 and 30 inches.

The crossbar 111 extends laterally from the tube 107 at the second end 133 of the tube 107. In one embodiment, the crossbar 111 is at the second end 133 of the tube 107 such that the crossbar 111 limits a penetration depth of the hay spear 305 into a hay bale when the three point hay lift 105 is installed on the hay spear device 103. In one embodiment, when the three point hay lift 105 is installed on the hay spear device 103, the hay spear 305 extends between 24 and 36 inches from the second end 133 of the tube 107.

The hay lift stabilizer 113 extends longitudinally from the crossbar 111 past the second end 133 of the tube 107. The hay lift stabilizer 113 is generally parallel to the longitudinal axis 114 and not collinear with the longitudinal axis 114. In one embodiment, the hay lift stabilizer 113 is a first hay lift stabilizer at a first end of the crossbar 111, and the three point hay lift 105 further includes a second hay lift stabilizer 150 extending longitudinally from the crossbar 111 at a second end of the crossbar 111. The second end of the crossbar 111 is laterally opposite the first end of the crossbar 111. The second hay lift stabilizer 150 is generally parallel to the longitudinal axis 114 and not collinear with the longitudinal axis 114. In one embodiment, the first hay lift stabilizer 113 and the second hay lift stabilizer 150 have a length of between 12 and 20 inches.

In one embodiment, the three point hay lift 105 further includes a strap 140 configured to secure the three point hay lift 105 to the frame 303 supporting the hay spear 305 such that the three point hay lift 105 is retained on the hay spear 305 when the three point hay lift 105 is installed on the hay spear device 103. In one embodiment, the strap 140 is configured to attach to the ear 109 and wrap around frame 303 supporting the hay spear 305 to retain the three point hay lift 105 on the hay spear device 103.

The ear 109 extends longitudinally past the first end 131 of the tube 107. The ear 109 is generally parallel to the longitudinal axis 114 and not collinear with the longitudinal axis 114. The ear 109 is configured to contact the frame 303 supporting the hay spear 305 and limit rotation of the tube 107 about the hay spear 305 when the three point hay lift 105 installed on the hay spear device 103. In one embodiment, the ear 109 is attached to the tube 107 at the first end 131 of the tube 107. In one embodiment, the ear 109 is a first ear, and the three point hay lift 103 further includes a second ear 143 laterally opposite the first ear 109. The second ear 143 extends longitudinally past the first end 131 of the tube 107 generally parallel to the longitudinal axis 114 and not collinear with the longitudinal axis 114. The second ear 143 is configured to contact the frame 303 supporting the hay spear 305 and cooperate with the first ear 109 to limit rotation of the tube 107 about the hay spear 305 when the three point hay lift 105 is installed on the hay spear device 103. In one embodiment, the strap 140 is configured to attach to the first ear 109, wrap around the frame 303 supporting the hay spear 305 (i.e., the upright 311), and selectively attached to the second ear 143 to retain the three point hay lift 105 on the hay spear device 103.

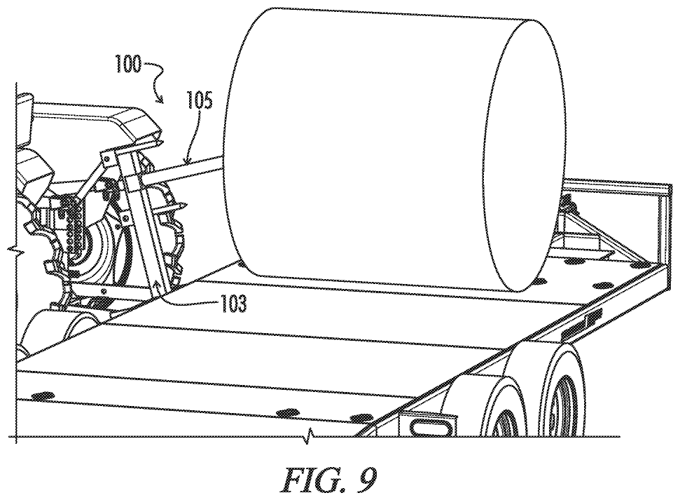

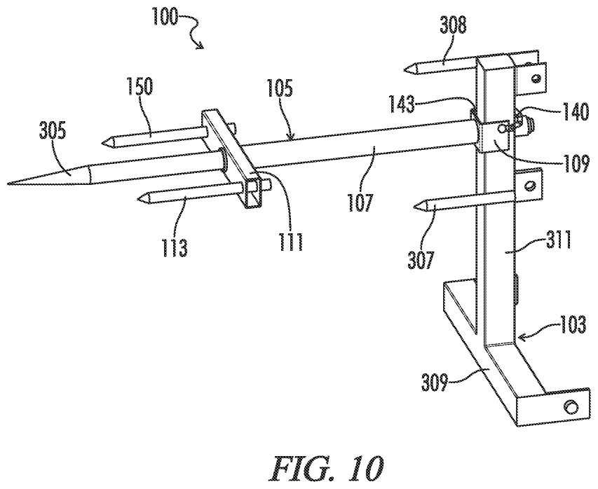

In operation, because the first and second stabilizers 307, 308 are on the upright 311 instead of the drawbar 309, the hay spear device 103 may be lowered to the ground with the hay spear 305 over a trailer without the hay spear 305 or the stabilizers 307, 308 contacting the trailer bed. This allows a user to lift a hay bale up over a trailer bed and lower the hay bale onto the trailer bed to load the hay bale on the trailer as shown in FIG. 9. In one embodiment as shown in FIG. 10, the first hay spear stabilizer 307 and second hay spear stabilizer 308 are located approximately 8-12 inches below and above the hay spear 304, respectively, on the upright 311. This allows for more resistance to twisting while utilizing smaller (i.e., shorter) hay spear stabilizers.

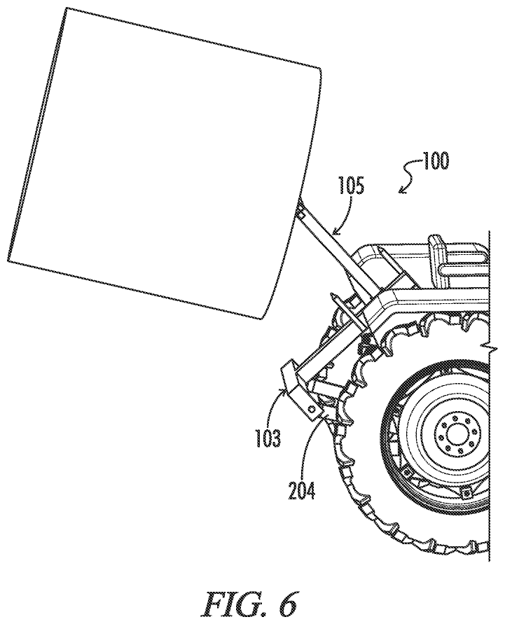

Because the crossbar 111 of the three point hay lift 105 limits penetration of the hay spear 305 into the hay bale, the assembly 100 enables a user to achieve a higher maximum height of a hay bale lifted by the assembly 100. Additionally, the limited penetration depth of the hay spear 305 levels the hay bale lifted by the assembly 100 such that a user may place a hay bale in a stack as shown in FIGS. 6-8. In one embodiment, the hay spear 305 is between about 36 and 48 inches long. The tube 107 is between about 18 and 28 inches long. The length of the hay spear 305 and tube 107 are selected such that a section of hay spear 305 extending beyond the tube 107 is approximately half the width (or depth) of a round hay bale to be handled by the system 100.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful THREE POINT HAY LIFT SYSTEM it is not intended that such references be construed as limitations upon the scope of this invention except as set forth in the following claims

What is claimed is:

1. A three point hay lift comprising:
a tube extending longitudinally along a longitudinal axis and is configured to receive a hay spear therein, said tube having a first end and a second end, said second end longitudinally opposite the first end;
an ear extending longitudinally past the first end of the tube, wherein the ear is generally parallel to the longitudinal axis and not collinear with the longitudinal axis such that the ear is configured to contact a frame supporting the hay spear and limit rotation of the tube about the hay spear when the three point hay lift is installed on the hay spear device;
a crossbar extending laterally from the tube at the second end of the tube; and
a hay lift stabilizer extending longitudinally from the crossbar past the second end of the tube, wherein the hay lift stabilizer is generally parallel to the longitudinal axis and not collinear with the longitudinal axis.

2. The three point hay lift of claim 1, wherein:
the three point hay lift further comprises a strap configured to secure the three point hay lift to the frame supporting the hay spear such that the three point hay lift is retained on the hay spear when the three point hay lift is installed on the hay spear device.

3. The three point hay lift of claim 1, wherein:
the ear is attached to the tube at the first end of the tube.

4. The three point hay lift of claim 1, wherein:
the three point hay lift further comprises a strap configured to secure the three point hay lift to the frame supporting the hay spear such that the three point hay lift is retained on the hay spear when the three point hay lift is installed on the hay spear;
the strap is configured to attached to the ear, wrap around the frame supporting the hay spear.

5. The three point hay lift of claim 1, wherein:
the three point hay lift further comprises a strap configured to secure the three point hay lift to the frame supporting the hay spear such that the three point hay lift is retained on the hay spear when the three point hay lift is installed on the hay spear device;
the ear is a first ear;
the three point hay lift further comprises a second ear laterally opposite the first ear, wherein the second ear extends longitudinally past the first end of the tube generally parallel to the longitudinal axis and not collinear with the longitudinal axis such that second the ear is configured to contact the frame supporting the hay spear and cooperate with the first ear to limit rotation of the tube about the hay spear when the three point hay lift is installed on the hay spear device;
the strap is configured to attached to the first ear, wrap around the frame supporting the hay spear, and selectively attach to the second ear to retain the three point hay lift on the hay spear.

6. The three point hay lift of claim 1, wherein:
the tube has a length less than half a length of the hay spear.

7. The three point hay lift of claim 1, wherein:
the hay lift stabilizer is a first hay lift stabilizer;
the first hay lift stabilizer is at a first end of the crossbar; and
the three point hay lift further comprises a second hay lift stabilizer extending longitudinally from the crossbar at a second end of the crossbar and laterally opposite the first end the crossbar past the second end of the tube, wherein the second end of the crossbar is laterally opposite the first end of the crossbar, wherein the second hay lift stabilizer is generally parallel to the longitudinal axis and not collinear with the longitudinal axis.

8. The three point hay lift of claim 1, wherein:
the tube has a length between 12 and 30 inches.

9. The three point hay lift of claim 1, wherein:
the hay lift stabilizer has a length of between 12 and 20 inches.

10. The three point hay lift of claim 1, wherein:
the crossbar is at the second end of the tube such that the crossbar limits a penetration depth of the hay spear into a hay bale when the three point hay lift is installed on the hay spear device.

11. The three point hay lift of claim 1, wherein:
when the three point hay lift is installed on the hay spear device, the hay spear extends between 24 and 36 inches from the second end of the tube.

12. A hay spear device comprising:
a frame configured to attach to a three point hitch;
a hay spear extending longitudinally along a longitudinal axis, said hay spear attached to and supported by the frame; and
a hay spear stabilizer extending longitudinally from the frame, said hay spear stabilizer extending generally parallel to the longitudinal axis and is not collinear with the longitudinal axis, wherein
the hay spear stabilizer is less than 24 inches from the hay spear.

13. The hay spear device of claim 12, wherein:
the frame comprises:
a drawbar configured to extend between a pair of lift arms of the three point hitch; and
an upright configured to extend from a center of the drawbar to a toplink of the three point hitch.

14. The hay spear device of claim 12, wherein:
the frame comprises:
a drawbar configured to extend between a pair of lift arms of the three point hitch; and
an upright configured to extend from a center of the drawbar to a toplink of the three point hitch;
the hay spear is laterally centered with respect to the upright and drawbar;
the hay spear stabilizer is not laterally centered with respect to the upright and the drawbar;
the hay spear stabilizer is a first hay spear stabilizer;
the hay spear assembly further comprises a second hay spear stabilizer; and
the first and second hay spear stabilizers are attached to opposing lateral sides of the upright.

15. The hay spear device of claim 12, wherein:
the hay spear has a length between about 36 and 60 inches.

16. The hay spear device of claim 12, wherein:
the hay spear stabilizer has a length of between 12 and 20 inches.

17. The hay spear device of claim 12, wherein:
the crossbar does not have a hay spear stabilizer permanently affixed thereto.

18. A hay spear and three point hay lift assembly comprising:
a hay spear device comprising:
a frame configured to attach to a three point hitch;
a hay spear extending longitudinally along a longitudinal axis, said spear attached to and supported by the frame; and
a hay spear stabilizer extending longitudinally from the frame, said hay spear stabilizer extending generally parallel to the longitudinal axis and not collinear with the longitudinal axis, wherein
the hay spear stabilizer is less than 24 inches from the hay spear; and
a three point hay lift comprising:
a tube extending longitudinally along the longitudinal axis when the three point hay lift is installed on the hay spear device, wherein the tube is configured to receive the hay spear therein when installed on the hay spear device, said tube having a first end and a second end, said second end longitudinally opposite the first end;
an ear extending longitudinally past the first end of the tube, wherein the ear is generally parallel to the longitudinal axis and not collinear with the longitudinal axis such that the ear is configured to contact the frame supporting the hay spear and limit rotation of the tube about the hay spear when the three point hay lift is installed on the hay spear device;
a crossbar extending laterally from the tube at the second end of the tube; and
a hay lift stabilizer extending longitudinally from the crossbar past the second end of the tube, wherein the hay lift stabilizer is generally parallel to the longitudinal axis and not collinear with the longitudinal axis.

19. The hay spear and three point hay lift assembly of claim 18, wherein:
the hay spear has a length greater than a length of the tube by between 24 and 40 inches.

20. The hay spear and three point hay lift assembly of claim 18, wherein:
the three point hay lift further comprises a strap configured to secure the three point hay lift to the frame supporting the hay spear such that the three point hay lift is retained on the hay spear when the three point hay lift is installed on the hay spear device;
the ear is a first ear;
the three point hay lift further comprises a second ear laterally opposite the first ear, wherein the second ear extends longitudinally past the first end of the tube generally parallel to the longitudinal axis and not collinear with the longitudinal axis such that second the ear is configured to contact an upright of the frame supporting the hay spear and cooperate with the first ear to limit rotation of the tube about the hay spear when the three point hay lift is installed on the hay spear device;
the strap is configured to attached to the first ear and selectively attach to the second ear to retain the three point hay lift on the hay spear when the three point hay lift is installed on the hay spear device such that the first ear, second ear first end of the tube, and strap encircle the upright of the frame supporting the hay spear.
